(19) United States
(12) Patent Application Publication
(10) Pub. No.: US 2008/0030652 A1
(43) Pub. Date: Feb. 7, 2008

(54) System for displaying image

(75) Inventors: Po-Chein Zhuang, Taipei (TW); Li-Chiao Huang, Taipei (TW)

Correspondence Address: BIRCH STEWART KOLASCH & BIRCH, PO BOX 747, FALLS CHURCH, VA, 22040-0747, US

(73) Assignee: TPO DISPLAYS CORP.

(21) Appl. No.: 11/882,295

(22) Filed: Jul. 31, 2007

(30) Foreign Application Priority Data
Aug. 2, 2006 (TW) 095128404
Aug. 3, 2006 (CN) 200610109239.8

(51) Int. Cl. G02F 1/1335; F21V 21/00; F21V 8/00

(52) U.S. Cl. 349/65; 362/612; 362/633

(57) ABSTRACT

A system for displaying images has a backlight module. The backlight module includes a light-guide, a frame and a lighting element. The frame holds the light-guide and has a first elastic element. The lighting element is held within the frame and has a first side and a second side opposite to each other. The first side touches the first elastic element of the frame. The second side touches the light-guide.

### CROSS REFERENCE TO RELATED APPLICATIONS

This Non-provisional application claims priority under 35 U.S.C. §119(a) on Patent Application No(s). 095128404 filed in Taiwan, Republic of China on Aug. 2, 2006, the entire contents of which are hereby incorporated by reference.

### BACKGROUND OF THE INVENTION

1. Field of Invention

The invention relates to a system for displaying images and, in particular, to an image-displaying system with a backlight module.

2. Related Art

FIG. 1 is a schematic view of a conventional backlight module. As shown in FIG. 1, a small-size backlight module 1, for example, has a frame 12, a light-guide 11, a light-emitting diode (LED) 13, and a plastic frame 14. The plastic frame 14 has a bottom plate 141 and several sidewalls 142. The frame body 12, the light-guide 11, and the LED 13 are disposed on the bottom plate 141 of the plastic frame 14. The frame body 12 is disposed within the sidewalls 142 of the plastic frame 14.

The frame body 12 holds the light-guide 11. The LED 13 is disposed at one corner 121 of the frame body 12 as a point light source. Its light-emitting surface touches the light-guide 11 and emits light toward the inside of the frame body 12 onto the light-guide 11. The light-guide 11 reflects the light emitted by the LED 13, so that the beam goes out along the normal of the light-guide 11 after reflection, forming a surface light source. Furthermore, the backlight module 1 is disposed with many optical films (not shown) above the light-guide for homogenizing the outgoing light.

The frame body 12 is provided with two suspension arms 122. The suspension arms 122 and the LED 13 are installed on opposite sides of the light-guide 11. The suspension arm 122 is depressed by the light-guide 11 to generate an elastic restoring force. The elastic restoring force pushes the light-guide 11 against the frame body 12 and the LED 13, fixing the light-guide 11 and the LED 13 in the frame body 12.

Take the conventional backlight module 1 as an example. Its suspension arm 122 serves as a buffer for the frame body 12. It compensates for the space between the light-guide 11 and the frame body 12. Moreover, the gap between the light-guide 11 and the LED 13 affects the light-emitting efficiency of the backlight module. The efficiency is reduced by a larger gap. To solve this problem, the prior art uses the suspension arm 122 to push the light-guide 11 against the LED 13, thereby minimizing the gap between the light-guide 11 and the LED 13.

However, suppose the errors in the sizes of the LED 13 and the frame body 12 are relatively large in this structure. Even if the suspension arm 122 can push the entire light-guide 11 tightly against the frame body 12 and the LED 13, the light-guide 11 may damage the LED 13. Moreover, the light-emitting surface of the LED 13 cannot be guaranteed to be parallel to the light-guide 11.

During the assembly process of the backlight module 1, the light-guide 11 is first disposed inside the frame body 12. The light-guide 11 touches against the suspension arm 122, so that the suspension arm 122 pushes the entire light-guide 11 to touch tightly against the frame body 12. Afterwards, the LED 13 is inserted between the light-guide 11 and the frame body 12. However, a force has to be imposed on the LED 13 during the insertion in order to overcome the elastic restoring force of the suspension arm 122 imposed on the light-guide 11. Therefore, the light-emitting surface of the LED 13 is tightly in contact with the light-guide 11. The light-guide 11 is thus likely to damage the light-emitting surface of the LED 13.

Therefore, it is an important subject to provide an image-displaying system for solving the above mentioned problems.

### SUMMARY OF THE INVENTION

In view of the foregoing, the invention is to provide an image-displaying system with a structure that can reduce the gap between its lighting element and light-guide.

To achieve the above, the invention discloses an image-displaying system with a backlight module. The backlight module includes a light-guide, a frame body and a lighting element. The frame body holds the light-guide and has a first elastic element. The lighting element is held in the frame body and has a first side and a second side that are opposite to each other. The first side touches the first elastic element of the frame body, and the second side touches the light-guide.

As mentioned above, in the image-displaying system of the invention, the lighting element is directly pushed by the first elastic element to touch the light-guide. Therefore, the lighting element can be easily aligned with the light-guide so as to enhance the light-emitting efficiency of the backlight module.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional backlight module;

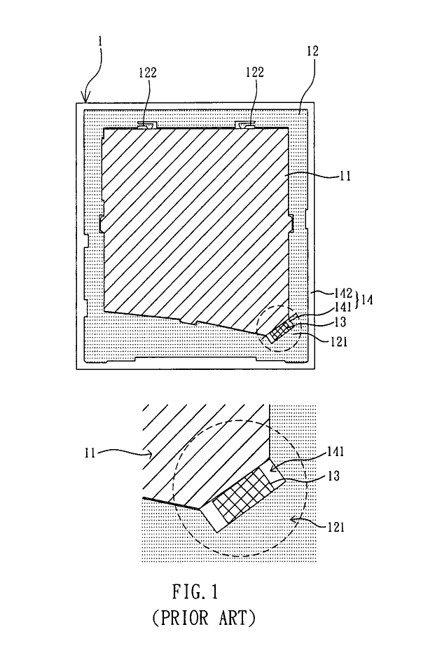

FIG. 2 is a schematic view of the image-displaying system according to an embodiment of the invention;

FIG. 3 is an enlarged view of a local part in FIG. 2;

FIG. 4 is a schematic view of the image-displaying system according to another embodiment of the invention; and

FIG. 5 is a block diagram of the disclosed image-displaying system.

### DETAILED DESCRIPTION OF THE INVENTION

The present invention will be apparent from the following detailed description, which proceeds with reference to the accompanying drawings, wherein the same references relate to the same elements.

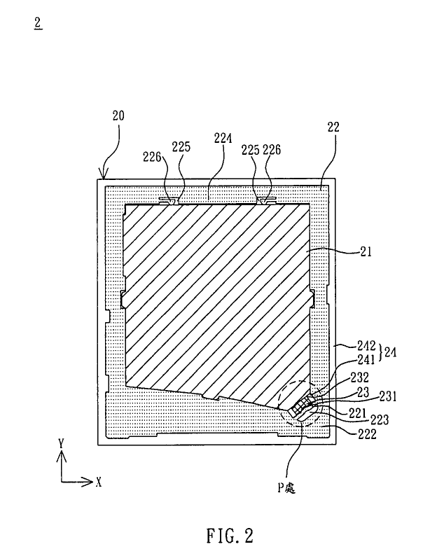

As shown in FIG. 2, an image-displaying system 2 according to the invention has a backlight module 20 that includes a light-guide 21, a frame body 22, a lighting element 23, and a plastic frame 24. The frame body 22 holds the light-guide 21 and has a first elastic element 221. The lighting element 23 is held in the frame body 22 and has a first side 231 and a second side 232 that are opposite to each other. The first side 231 touches the first elastic element 221 of the frame body 22, and the second side 232 touches the light-guide 21.

The first side 231 of the lighting element 23 touches against the first elastic element 221 of the frame body 22, so that the first elastic element 221 produces an elastic restoring force. The elastic restoring force pushes the first side 231 of the lighting element 23, so that the second side 232 of the lighting element 23 touches tightly against the light-guide 21. Therefore, there is no gap between the second side 232 of the lighting element 23 and the light-guide 21. The light-emitting efficiency of the backlight module 20 can thus be increased.

In this embodiment, the plastic frame 24 has a bottom plate 241 and several sidewalls 242. The frame body 22, the light-guide 21, and the LED 23 are disposed on the bottom plate 141 of the plastic frame 14. The frame body 12 is held within the sidewalls 142 of the plastic frame 14.

The edges of the frame body 22 are parallel to an X axis or a Y axis. The lighting element 23 and the first elastic element 221 are disposed at one corner 222 of the frame body 22. They are neither parallel nor perpendicular to the edges of the frame body 22. The first elastic element 221 does not simply push the lighting element 23 against an edge of the frame body 22. Therefore, the lighting element 23 can be restricted to positions on the X axis and the Y axis.

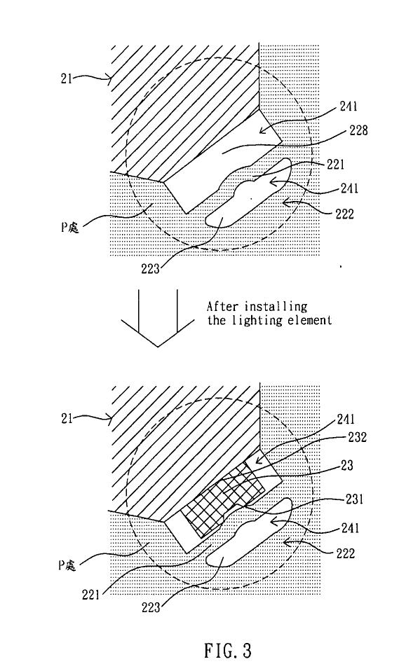

FIG. 3 is an enlarged view of a local part of FIG. 2. As shown in the drawing, the lighting element 23 is disposed at a cavity 228 at the corner 222. The frame body 22 in the vicinity of the cavity 228 is formed with a through hole 223 in order to form the first elastic element 221 between the cavity 228 and the through hole 223. The first elastic element 221 has the shape of a rib. Its central portion is an arc, with the protruding part thereof pushing the first side 231 of the lighting element 23.

The lighting element 23 interferes with the frame body 22. After the lighting element 23 is disposed at the corner 222, its second side 232 protrudes slightly from the inner edge of the frame body 22. The lighting element 23 can thus touch tightly against the first elastic element 221 and the light-guide 21.

The profile of the first elastic element 221 is designed according to the profile of the first side 231 of the lighting element 23, so that the first elastic element 221 and the first side 231 of the lighting element 23 have a large contact surface. Therefore, the lighting element 23 can be more evenly pushed. The lighting element 23 is more stably disposed between the first elastic element 221 and the light-guide 21.

Please refer to FIG. 2 again. An inner side 224 of the frame body 22 that is opposite to the LED 23 has two through holes 225 and two second elastic elements 226. The second elastic elements 226 are formed by the through hole 225. Each of them is a suspension arm with a cylindrical tail. The second elastic elements 226 and the LED 23 are disposed on two sides of the light-guide 21. The second elastic elements 226 push the light-guide 21 so that the light-guide 21 touches toward the lighting element 23 and tightly against the frame body 22. The shapes of the two second elastic elements 226 are symmetric in order to ensure the even push on the light-guide 21.

The second elastic element 226 pushes the light-guide 21 tightly against the frame body 22. The first elastic element 221 pushes the lighting element 23 to align with the light-guide 21. Therefore, the light-guide 21 and the lighting element 23 can be stably held inside the frame body 22, and the gap between the light-guide 21 and the lighting element 23 can be reduced. As a result, the light-emitting efficiency of the backlight module 20 can be enhanced.

Additionally, during the assembly of the backlight module 20, the light-guide 21 is first disposed inside the frame body 22. The light-guide 21 touches against the second elastic element 226, so that the second elastic element 226 pushes the entire light-guide 21 tightly against the frame body 22. Afterwards, the lighting element 23 touches against the first elastic element 221, putting the lighting element 23 between the light-guide 21 and the frame body 22. The elastic restoring force generated by the first elastic element 221 pushes the lighting element 23 to touch the light-guide 21. Therefore, there is no need to impose a force on the lighting element toward the second elastic element 226 when installing the lighting element 23 between the light-guide 21 and the frame body 22. Therefore, the invention prevents the light-guide 21 from scratching or damaging the lighting element 23.

The frame body 22 can be formed by plastic injection molding. The shapes of the first elastic element 221, the second elastic element 226 and the through holes 223, 225 can be defined in the mold during the injection molding process. Once plastic is injected into the mold, the frame body 22 in FIG. 2 is formed. The first elastic element 221 and the second elastic element 226 are directly formed on the frame body 22 without additional machining.

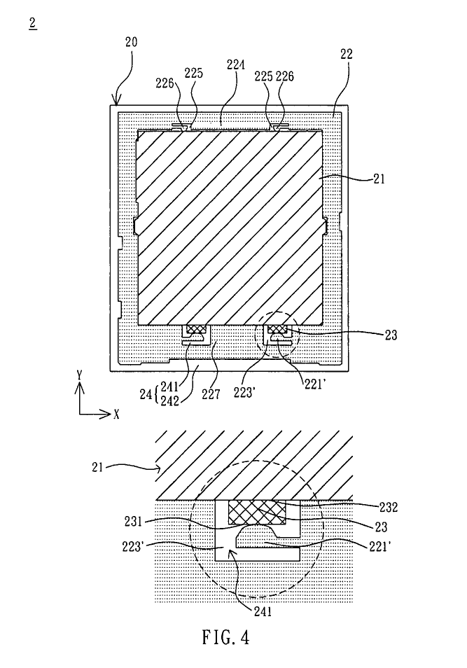

FIG. 4 is a schematic view of the image-displaying system according to another embodiment of the invention. As shown in the drawing, a difference from FIG. 3 is that the backlight module 20 is disposed with two lighting elements 23 and two first elastic elements 221′ on an inner side 227 of the frame body 22. The two first elastic elements 221′ are suspension arms with cylindrical tails. Their shapes are symmetric to ensure an even push on the lighting elements 23. Additionally, the first elastic elements 221′ and the second elastic elements 226 are opposite to each other. These elastic elements produce elastic restoring forces toward one another to push the lighting elements 23 and the light-guide 21. The lighting elements 23 and the light-guide 21 press firmly against each other to minimize the gap in between, thereby increasing the light-emitting efficiency of the backlight module 20.

In the above-mentioned embodiments, the image-displaying system 2 can further include a liquid crystal display (LCD) device. The LCD device has the above-mentioned backlight module 20 and an LCD panel. The backlight module 20 outputs a light beam to the LCD panel for it to display images.

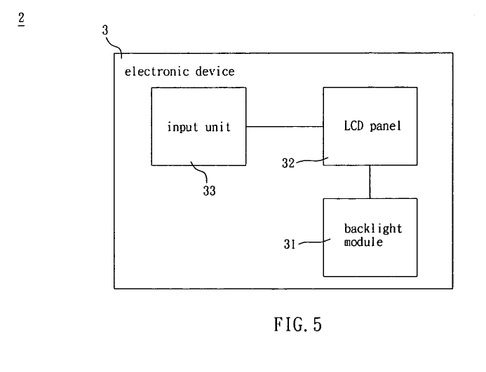

FIG. 5 is a block diagram for the disclosed image-displaying system. With simultaneous reference to FIG. 4, the disclosed image-displaying system 2 has an electronic device 3 with a backlight module 31, an LCD panel 32, and an input unit 33. The backlight module 31 has the same structure, purposes, and effects as the backlight module 20 in the previous embodiments. Its various implementations have been disclosed in those embodiments.

The backlight module 31 outputs a beam of light to the LCD panel 32. The input unit 33 couples to the LCD panel 32 and provides an input to the LCD panel 32 for it to display images. The electronic device 3 can be a mobile phone, a digital camera, a personal digital assistant, a laptop computer, a desktop computer, a television, a vehicle display, a head-cap display, a printer screen, an MP3 player, a hand-held game machine, or a portable DVD player.

In summary, the lighting element of the invention is in touch with the light-guide under the direct push of the first elastic element. Therefore, the lighting element can be easily aligned with the light-guide so as to enhance the light-emitting efficiency of the backlight module.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An image-displaying system with a backlight module, the backlight module comprising:
a light-guide;
a frame body, which holds the light-guide and has a first elastic element; and
a lighting element, which is held in the frame body and has a first side and a second side that are opposite to each other, wherein the first side touches the first elastic element of the frame body, and the second side touches the light-guide.

2. The image-displaying system of claim 1, wherein the first elastic element pushes the first side of the lighting element so that the second side of the lighting element presses firmly against the light-guide.

3. The image-displaying system of claim 1, wherein the second side of the lighting element aligns with the light-guide.

4. The image-displaying system of claim 1, wherein the first elastic element is a rib.

5. The image-displaying system of claim 4, wherein the central portion of the first elastic element has an arc.

6. The image-displaying system of claim 4, wherein the first elastic element has a profile designed according to a profile of the first side of the lighting element.

7. The image-displaying system of claim 1, wherein the first elastic element is a suspension arm.

8. The image-displaying system of claim 7, wherein the first elastic element has a cylindrical tail.

9. The image-displaying system of claim 1, wherein the frame body has a cavity, and the first elastic element is formed adjacent to the cavity.

10. The image-displaying system of claim 1, wherein the frame body further comprises a second elastic element for pushing the light-guide toward the lighting element and to touch tightly against the frame body.

11. The image-displaying system of claim 10, wherein the second elastic element is a suspension arm.

12. The image-displaying system of claim 10, wherein the second elastic element has a cylindrical tail.

13. The image-displaying system of claim 10, wherein the frame body has a cavity, and the second elastic element is formed adjacent to the cavity.

14. The image-displaying system of claim 1, wherein the lighting element is disposed at one corner of the frame body.

15. The image-displaying system of claim 1, wherein the lighting element is disposed on an inner edge of the frame body.

16. The image-displaying system of claim 1, wherein the lighting element is light emitting diode (LED).

17. The image-displaying system of claim 1 further comprising:
a liquid crystal display (LCD) device having the backlight module and a liquid crystal display (LCD) panel, wherein the backlight module outputs a beam of light to the LCD panel for the LCD panel to display images.

18. The image-displaying system of claim 1 further comprising:
an electronic device having the backlight module, a liquid crystal display (LCD) panel and an input unit, wherein the backlight module outputs a beam of light to the LCD panel, and the input unit couples to the LCD panel and provides an input to the LCD panel for the LCD panel to display images.

19. The image-displaying system of claim 18, wherein the electronic device is a mobile phone, a digital camera, a personal digital assistant, a laptop computer, a desktop computer, a television, a vehicle display or a portable DVD player.
